(19) United States
(12) Patent Application Publication
(10) Pub. No.: US 2011/0145882 A1
(43) Pub. Date: Jun. 16, 2011

(54) MULTI-CHANNEL DIGITAL TV TRANSMISSION SYSTEM AND METHOD

(75) Inventors: Sung Woong Choi, Daejeon (KR); Heon Jin Hong, Daejeon (KR)

(73) Assignee: ELECTRONICS AND TELECOMMUNICATIONS RESEARCH INSTITUTE, Daejeon (KR)

(21) Appl. No.: 12/947,587

(22) Filed: Nov. 16, 2010

(30) Foreign Application Priority Data
Dec. 16, 2009 (KR) 10-2009-0125365
Feb. 16, 2010 (KR) 10-2010-0013758

(51) Int. Cl. H04N 7/173

(52) U.S. Cl. 725/127

(57) ABSTRACT

A multi-channel digital TV transmission system and method are provided. In the multi-channel digital TV transmission system and method, a single auxiliary transmitter may be configured to be switched with respect to a plurality of main transmitters and thus, it is possible to provide a broadcasting service without interruption even when an fault occurs in a main transmitter among the plurality of main transmitters, to reduce costs of a multi-channel digital TV transmission system, and to ensure a wide facility space.

### CROSS-REFERENCE TO RELATED APPLICATIONS

This application claims the benefit of Korean Patent Application No. 10-2009-0125365 and of Korean Patent Application No. 10-2010-0013758, respectively filed on Dec. 16, 2009 and Feb. 16, 2010 in the Korean Intellectual Property Office, the disclosures of which are incorporated herein by reference.

### BACKGROUND

1. Field of the Invention

The present invention relates to a multi-channel digital TV transmission system and method, and more particularly, to a multi-channel digital TV transmission system and method that may provide a broadcasting service without interruption by switching a main transmitter to an auxiliary transmitter when an fault occurs in the main transmitter.

2. Description of the Related Art

Currently, Korean domestic TV broadcasting services are provided through 68 channels in a frequency band of 54 to 806 megahertz (MHz) with a bandwidth of 6 MHz for each channel National and local commercial broadcast providers, such as KBS, MBC, EBS, SBS and the like, are managing 1436 broadcasting stations including 1191 analog broadcasting stations and 245 digital broadcasting stations. Out of all households nationwide, approximately 96% of households receive analog TV broadcasting and approximately 86% of households receive digital TV broadcasting. To raise reception level of digital TV broadcasting to a level of analog TV broadcasting, a large number of digital TV broadcasting stations are additionally required.

Generally, a TV transmitter includes a main transmitter and an auxiliary transmitter for all channels. For example, when an fault occurs in a main transmitter, the main transmitter may be switched to an auxiliary transmitter, so that a broadcasting service may continue to be provided through corresponding channels without interruption.

TV broadcasting-related devices include expensive and bulky components. In other words, high costs may be incurred and a facility space may become limited due to assignment of a main transmitter and an auxiliary transmitter for each channel.

### SUMMARY

An aspect of the present invention provides a scheme that may enable a single auxiliary transmitter to be switched with respect to a plurality of main transmitters, so that a broadcasting service may be provided without interruption even when an fault occurs in a main transmitter among the plurality of main transmitters, that may reduce costs of a multi-channel digital TV transmission system, and that may ensure a wide facility space.

According to an aspect of the present invention, there is provided a multi-channel digital TV transmission system for providing a plurality of channels, the multi-channel digital TV transmission system including a plurality of main transmitters to transmit digital TV signals respectively corresponding to the plurality of channels, a plurality of switches respectively connected to the plurality of main transmitters, and an auxiliary transmitter. Here, when an fault occurs in a main transmitter among the plurality of main transmitters, a switch connected to the main transmitter may switch the main transmitter to the auxiliary transmitter.

According to another aspect of the present invention, there is provided a multi-channel digital TV transmission system for providing a plurality of channels, the multi-channel digital TV transmission system including a plurality of main transmitters to transmit digital TV signals respectively corresponding to the plurality of channels, and an auxiliary transmitter. Each of the plurality of main transmitters may include a main transmitter modulator to modulate an input signal for broadcast contents that are provided by the plurality of channels, a switch to switch the main transmitter modulator to the auxiliary transmitter, a frequency up-converter to up-convert a frequency of the modulated input signal, and a High Power Amplifier (HPA) to amplify an output of the modulated input signal of which the frequency is up-converted. When an fault occurs in a main transmitter among the plurality of main transmitters, the switch may switch the main transmitter modulator to the auxiliary transmitter.

According to still another aspect of the present invention, there is provided a multi-channel digital TV transmission method for providing a plurality of channels, the multi-channel digital TV transmission method including switching a main transmitter among a plurality of main transmitters to an auxiliary transmitter when an fault occurs in the main transmitter, the plurality of main transmitters transmitting digital TV signals respectively corresponding to the plurality of channels, and transmitting, by the auxiliary transmitter, a digital TV signal corresponding to the main transmitter where the fault occurred.

### EFFECT

According to embodiments of the present invention, a single auxiliary transmitter may be configured to be switched with respect to a plurality of main transmitters and thus, it is possible to provide a broadcasting service without interruption even when an fault occurs in a main transmitter among the plurality of main transmitters, to reduce costs of a multi-channel digital TV transmission system, and to ensure a wide facility space.

### BRIEF DESCRIPTION OF THE DRAWINGS

These and/or other aspects, features, and advantages of the invention will become apparent and more readily appreciated from the following description of exemplary embodiments of the present invention, taken in conjunction with the accompanying drawings of which:

FIG. 1 is a diagram illustrating a multi-channel digital TV transmission system according to an embodiment of the present invention;

FIG. 2 is a diagram illustrating a multi-channel digital TV transmission system according to another embodiment of the present invention; and

FIG. 3 is a flowchart illustrating a multi-channel digital TV transmission method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

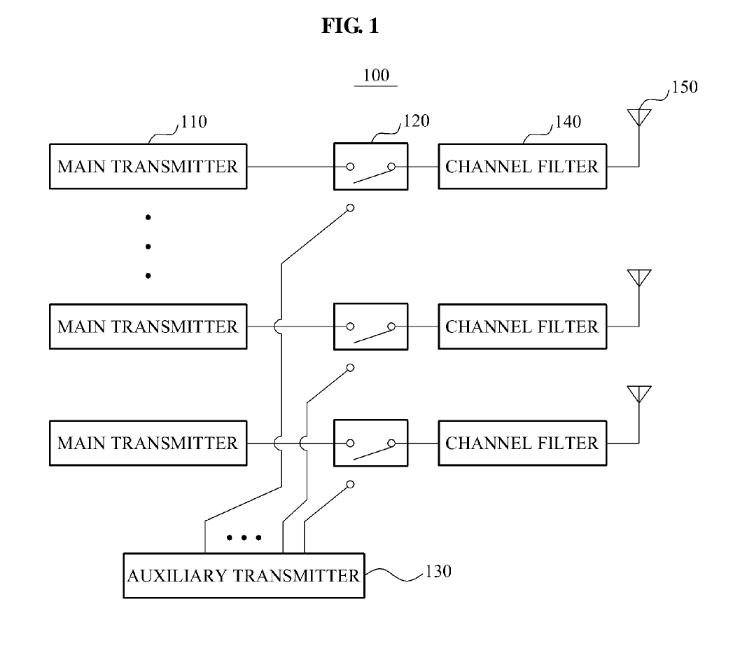

FIG. 1 is a diagram illustrating a multi-channel digital TV transmission system 100 according to an embodiment of the present invention.

Referring to FIG. 1, the multi-channel digital TV transmission system 100 includes a plurality of main transmitters 110, a plurality of switches 120, and an auxiliary transmitter 130.

The multi-channel digital TV transmission system 100 may be implemented by a network configured to provide a plurality of broadcast channels.

The main transmitters 110 may transmit digital TV signals that respectively correspond to a plurality of channels provided by the multi-channel digital TV transmission system 100. Depending on embodiments, a digital TV signal may include, for example, data containing information regarding broadcast contents provided by broadcast channels.

According to an embodiment, a main transmitter 110 may transmit a digital TV signal to a channel filter 140 through a switch 120. Additionally, depending on embodiments, the main transmitter 110 may transmit a digital TV signal to a terminal device located in the multi-channel digital TV transmission system 100, through a switch 120 and an antenna 150.

Channel filters 140 may filter received digital TV signals in frequency domains of broadcast channels respectively corresponding to the main transmitters 110. Additionally, the channel filters 140 may transmit the filtered digital TV signals to the terminal device located in the multi-channel digital TV transmission system 100 through antennas 150.

The plurality of switches 120 may be respectively connected to the plurality of main transmitters 110.

According to an aspect of the present invention, when an fault occurs in a main transmitter among the plurality of main transmitters 110, a switch 120 connected to the main transmitter 110 where the fault occurred may switch the main transmitter 110 to the auxiliary transmitter 130.

Specifically, the switch 120 connected to the main transmitter 110 where the fault occurred may disconnect the main transmitter 110 from a channel filter 140, and may connect the auxiliary transmitter 130 to the channel filter 140.

Additionally, the auxiliary transmitter 130 may transmit a digital TV signal corresponding to the main transmitter 110 where the fault occurred. Depending on embodiments, the auxiliary transmitter 130 may transmit, to the channel filter 140, a digital TV signal containing information on a broadcast content provided by a channel corresponding to the main transmitter 110 where the fault occurred.

According to an aspect of the present invention, each of the main transmitters 110 may include a main transmitter modulator to modulate an input signal for broadcast contents provided by the plurality of channels. Here, the plurality of channels may respectively correspond to the plurality of main transmitters 110. Additionally, the auxiliary transmitter 130 may include an auxiliary transmitter modulator.

A switch 120 connected to a main transmitter 110 where an fault occurred may switch a main transmitter modulator of the main transmitter 110 to the auxiliary transmitter modulator of the auxiliary transmitter 130. Depending on embodiments, when an fault occurs in a main transmitter 110, a switch 120 may disconnect a channel filter 140 from a main transmitter modulator of the main transmitter 110 where the fault occurred, and may connect the channel filter 140 to the auxiliary transmitter modulator of the auxiliary transmitter 130. Here, the auxiliary transmitter modulator of the auxiliary transmitter 130 may modulate an input signal corresponding to the main transmitter 110 where the fault occurred.

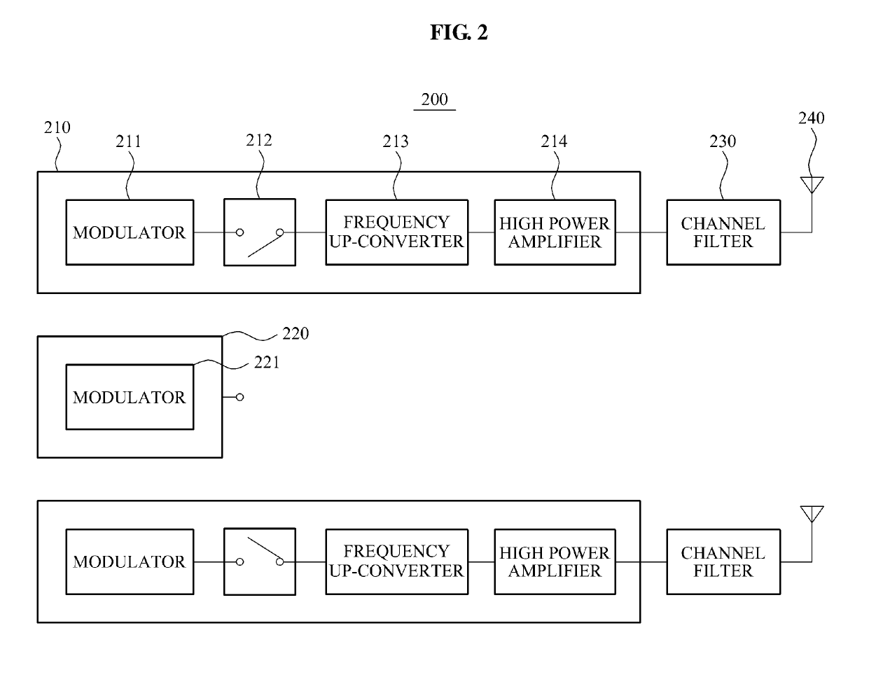

FIG. 2 is a diagram illustrating a multi-channel digital TV transmission system 200 according to another embodiment of the present invention.

Referring to FIG. 2, the multi-channel digital TV transmission system 200 may include a plurality of main transmitters 210, and an auxiliary transmitter 220.

Each of the main transmitters 210 may include a modulator 211, a switch 212, a frequency up-converter 213, and a High Power Amplifier (HPA) 214.

The modulator 211 may modulate an input signal for a broadcast content that is provided by a channel corresponding to the main transmitter 210.

The switch 212 may switch the modulator 211 to the auxiliary transmitter 220.

The frequency up-converter 213 may receive the input signal modulated by the modulator 211, through the switch 212. Additionally, the frequency up-converter 213 may up-convert a frequency of the received input signal.

The HPA 214 may amplify an output of the modulated input signal of which the frequency is up-converted by the frequency up-converter 213. Additionally, the HPA 214 may transmit the signal of which the output is amplified before being transmitted to a channel filter 230. Here, the signal that is amplified may be a digital TV signal.

The channel filter 230 may receive a digital TV signal from the HPA 214. Additionally, the channel filter 230 may filter the received digital TV signal in a frequency domain of a broadcast channel corresponding to the main transmitter 210. Furthermore, the channel filter 230 may transmit the filtered digital TV signal to a terminal device located in the multi-channel digital TV transmission system 200, via an antenna 240.

When an fault occurs in the main transmitter 210, the switch 212 may switch the modulator 211 to the auxiliary transmitter 220. Depending on embodiments, when an fault occurs in the main transmitter 210, the switch 212 may disconnect the modulator 211 from the frequency up-converter 213, and may connect the auxiliary transmitter 220 to the frequency up-converter 213.

According to an aspect of the present invention, the auxiliary transmitter 220 may include an auxiliary transmitter modulator 221.

Depending on embodiments, when an fault occurs in the main transmitter 210, the switch 212 may switch the modulator 211 to the auxiliary transmitter modulator 221. Specifically, the switch 212 may disconnect the modulator 211 from the frequency up-converter 213, and may connect the auxiliary transmitter modulator 221 to the frequency up-converter 213.

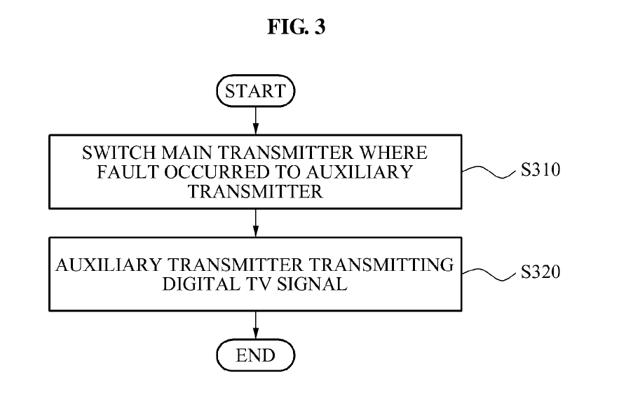

FIG. 3 is a flowchart illustrating a multi-channel digital TV transmission method according to an embodiment of the present invention.

The multi-channel digital TV transmission method of FIG. 3 may be performed to provide a plurality of channels. Referring to FIG. 3, when an fault occurs in a main transmitter of a plurality of main transmitters, the main transmitter where the fault occurred may be switched to an auxiliary transmitter in operation S310. Here, the plurality of main transmitters may transmit digital TV signals that respectively correspond to the plurality of channels.

The auxiliary transmitter may transmit a digital TV signal corresponding to the main transmitter where the fault occurred in operation 320.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multi-channel digital TV transmission system for providing a plurality of channels, the multi-channel digital TV transmission system comprising:
a plurality of main transmitters to transmit digital TV signals respectively corresponding to the plurality of channels;
a plurality of switches respectively connected to the plurality of main transmitters; and
an auxiliary transmitter,
wherein, when an fault occurs in a main transmitter among the plurality of main transmitters, a switch connected to the main transmitter switches the main transmitter to the auxiliary transmitter.

2. The multi-channel digital TV transmission system of claim 1, wherein the auxiliary transmitter transmits a digital TV signal corresponding to the main transmitter where the fault occurred.

3. The multi-channel digital TV transmission system of claim 1, wherein each of the plurality of main transmitters comprises a main transmitter modulator to modulate an input signal for broadcasts contents, the broadcasts contents being provided by the plurality of channels,
wherein the auxiliary transmitter comprises an auxiliary transmitter modulator, and
wherein the switch switches a main transmitter modulator of the main transmitter where the fault occurred to the auxiliary transmitter modulator.

4. The multi-channel digital TV transmission system of claim 3, wherein the auxiliary transmitter modulator modulates an input signal corresponding to the main transmitter where the fault occurred.

5. A multi-channel digital TV transmission system for providing a plurality of channels, the multi-channel digital TV transmission system comprising:
a plurality of main transmitters to transmit digital TV signals respectively corresponding to the plurality of channels; and
an auxiliary transmitter,
wherein each of the plurality of main transmitters comprises:
a main transmitter modulator to modulate an input signal for broadcast contents, the broadcast contents being provided by the plurality of channels;
a switch to switch the main transmitter modulator to the auxiliary transmitter;
a frequency up-converter to up-convert a frequency of the modulated input signal; and
a High Power Amplifier (HPA) to amplify an output of the modulated input signal of which the frequency is up-converted, and
wherein, when an fault occurs in a main transmitter among the plurality of main transmitters, the switch switches the main transmitter modulator to the auxiliary transmitter.

6. The multi-channel digital TV transmission system of claim 5, wherein the auxiliary transmitter comprises an auxiliary transmitter modulator to modulate an input signal corresponding to the main transmitter where the fault occurred.

7. A multi-channel digital TV transmission method for providing a plurality of channels, the multi-channel digital TV transmission method comprising:
switching a main transmitter among a plurality of main transmitters to an auxiliary transmitter when an fault occurs in the main transmitter, the plurality of main transmitters transmitting digital TV signals respectively corresponding to the plurality of channels; and
transmitting, by the auxiliary transmitter, a digital TV signal corresponding to the main transmitter where the fault occurred.
